(19) United States
(12) Patent Application Publication
(10) Pub. No.: US 2007/0223357 A1
(43) Pub. Date: Sep. 27, 2007

(54) Head Range Controlled Jumping

(75) Inventors: Ivon Franciscus Helwegen, Eindhoven (NL); Henricus Renatus Martinus Verberne, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,515

(22) PCT Filed: Apr. 28, 2005
(86) PCT No.: PCT/IB05/51395

§ 371 Date: Oct. 31, 2006

(30) Foreign Application Priority Data
May 4, 2004 (EP) 04101898.7

(51) Int. Cl. G11B 7/26

(52) U.S. Cl. 369/284

(57) ABSTRACT

A record carrier has pattern of substantially parallel tracks constituting a data area, and a first and second boundary mark on predefined transverse positions bordering the data area. An optical disc drive scans the record carrier via a beam of radiation (24) from a head (22). The device has a control unit for determining a position of a selected track, and a tracking system for positioning the head on the selected track via a jump by a motor (40) that moves the head transverse to the tracks. The device has a head range unit (32) for detecting the boundary marks via the beam and controlling the motor for limiting said transverse movement of the head to a head range corresponding to the data area bordered by the boundary marks. Hence the motor is stopped (48) to prevent the head from exceeding head range corresponding to the data area without position sensors or mechanical elements.

The invention relates to a device for scanning a selected track in a pattern of substantially parallel tracks on a record carrier via a beam of radiation, the device comprising a head for providing the beam, control means for determining a position of the selected track, tracking means for positioning the head on the selected track via a jump, the tracking means comprising a motor for moving the head transverse to the tracks.

The invention further relates to a record carrier having a pattern of substantially parallel tracks to be scanned via a beam of radiation.

U.S. Pat. No. 6,215,739 describes an optical storage device. The device has a head including a pickup unit on a carriage for generating a scanning spot on the track via a beam of light. Information is represented by marks in the tracks. The optical storage device is equipped with a positioning system to position the head on a selected track of a record carrier by moving the carriage along a rail via a motor, such positioning usually called seeking. During a jump the motor is controlled via a driver based on a difference between a target position and an actual position determined by a microcomputer control unit. The actual distance of movement of the pickup unit during jumping is determined by counting a number of tracks that is crossed. The target position is calculated from a physical address of the data to be retrieved from the record carrier. The physical address indicates a distance in the longitudinal direction of the track. A distance in said longitudinal direction can be easily determined from the current physical address and the target physical address. However, the head is to be moved transverse to the tracks across the pattern of parallel tracks, i.e. in the radial direction of the disc shaped record carrier. For calculating, from the longitudinal distance, the number of tracks to be crossed, it is necessary to know the track pitch, i.e. the distance between the centers of neighboring tracks, because the track pitch may vary for different record carriers. The actual track pitch is measured by making a jump over a known distance and count the number of tracks crossed. Hence the document shows a way of controlling the movement of the head based on counting a number of tracks crossed during jumping. However, the prior art positioning system requires that the tracks crossed during jumping are accurately counted. For high density optical record carriers and high speed jumping such counting is difficult to achieve.

Therefore it is an object of the invention to provide a positioning system in a scanning device that provides control of the movement of the head during jumping without the need for accurate track counting.

According to a first aspect of the invention the object is achieved with a device as defined in the opening paragraph for scanning a selected track in a pattern of substantially parallel tracks on a record carrier via a beam of radiation, the record carrier comprising a first boundary mark on a predefined first transverse position, and a second boundary mark on a predefined second transverse position, the first and second boundary mark bordering the pattern of substantially parallel tracks, and the device comprising head range means for detecting the boundary marks via the beam and controlling the motor for limiting said transverse movement of the head to a head range corresponding to the pattern of substantially parallel tracks bordered by the boundary marks.

According to a second aspect of the invention the object is achieved with a record carrier as defined in the opening paragraph, which record carrier comprises a first boundary mark on a predefined first transverse position, and a second boundary mark on a predefined second transverse position, the first and second boundary mark bordering the pattern of substantially parallel tracks.

The pattern of substantially parallel tracks constitutes a data area where data is encoded, or may be recorded, in marks in the tracks. The data area constitutes the total functionally usable storage area of the record carrier, which is enclosed by the boundary marks. The effect of the measures is that the range of movement of the head in the transverse direction is limited to the head range that just covers the data area, i.e. which is limited to the range between the transverse positions of the boundary marks on the record carrier. During a jump the motor will be stopped when the head reaches the boundary marks. Hence the head will never be positioned beyond the boundary marks. This has the advantage that the range of movement of the head is controlled to a functionally useful and safe range corresponding to the storage area of the record carrier. In particular it is advantageous that the head never arrives at a position outside the pattern of substantially parallel tracks, i.e. the data area of the actual record carrier inserted. Hence, even if the head positioning system received a command to access a physical address outside the actually available data area or in an erroneous jump process, the head would be stopped at the transverse position of the boundary mark, and would be travel to a far away position. Hence, for a next jump command, the head will be able to quickly access a next physical address within the data area.

The invention is also based on the following recognition. Commonly the seeking of selected tracks in optical drives is based on counting tracks during jumping. The inventors have seen that in high density optical recording counting tracks is not reliable, in particular during high speed jumping. Moreover, when counting is unreliable, or when relative distance based jumping is used, there is a danger that the movement of the head is continued beyond the maximal mechanical range of the head and sledge or carriage mechanism. Physical damage or excessive wear may occur when the motor continues to drive the head when the ultimate mechanical position is reached. Although it may be possible to include position sensors and/or mechanical end stops in the sledge mechanism to control the maximum mechanical range, such additional sensors and/or mechanical end stops increase the cost and size of the device. By adjusting the range of movement of the head to the data area on the record carrier, such additional elements are not necessary.

In an embodiment of the device the head range means are arranged for detecting the boundary marks via the beam during said jump. The head range means are continuously monitoring a signal generated via the beam during said jump for detecting the boundary marks. This has the advantage that the limits of the movement of the head are detected independently of a calculated distance of head movement.

In an embodiment of the device the head range means comprises detection means for detecting, from a detector signal from the head, an amount of reflected radiation deviating at least a predetermined amount from an amount of reflected radiation from the pattern of substantially parallel tracks. This has the advantage that the total reflected radiation can be easily monitored for detecting the boundary marks, e.g. by a simple threshold circuit.

In an embodiment of the device the control means are arranged for, after inserting the record carrier, performing a calibration process based on the boundary marks for determining and storing the head range, and the head range means are arranged for limiting said transverse movement of the head based on the stored head range. The calibration process is initially performed, and the result is stored. The actual movement of the head is compared with the stored head range. This has the advantage that any delays caused by detecting the boundary marks are only affecting the initialization process. The actual movement of the head usually is monitored for accurately arriving at a destination track, and a simple comparison can be made with the stored limits of the head range.

In an embodiment of the record carrier the boundary marks are highly reflective boundary strips having a reflection that is at least a predefined amount above an average reflection of the pattern of substantially parallel tracks. This has the advantage that a high reflection can be easily detected in a scanning device.

Further preferred embodiments of the device according to the invention are given in the appended claims, disclosure of which is incorporated herein by reference.

These and other aspects of the invention will be apparent from and elucidated further with reference to the embodiments described by way of example in the following description and with reference to the accompanying drawings, in which

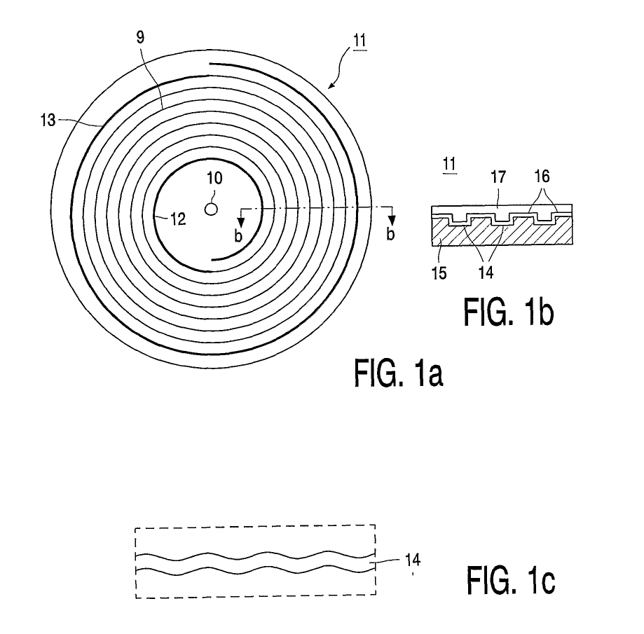

FIG. 1a shows a disc-shaped record carrier,

FIG. 1b shows a cross-section taken of the record carrier,

FIG. 1c shows an example of a wobble of the track,

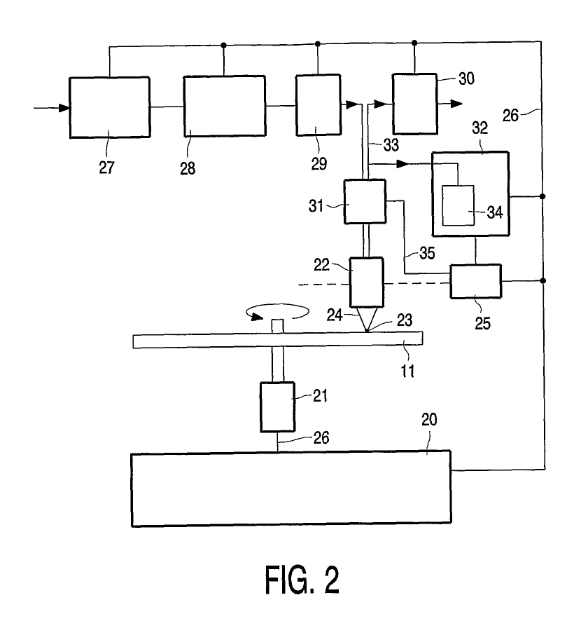

FIG. 2 shows a scanning device having head range controlled jumping,

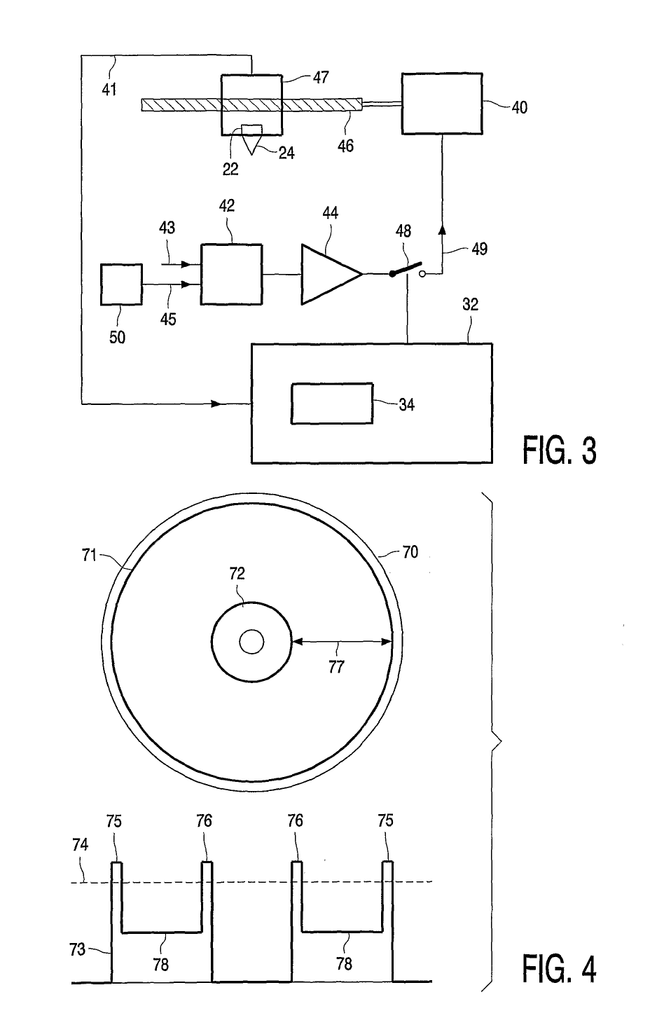

FIG. 3 shows a tracking servo system for positioning the head on the track and limiting the transverse movement to a head range,

FIG. 4 shows a record carrier having boundary strips and a reflected signal level, and

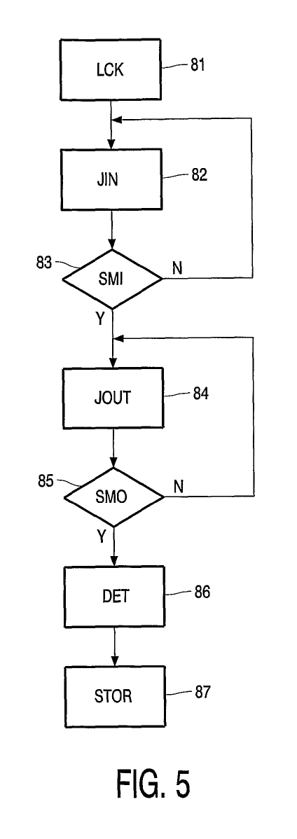

FIG. 5 shows a flow chart of a head range calibration procedure.

In the Figures, elements which correspond to elements already described have the same reference numerals.

FIG. 1a shows a disc-shaped record carrier 11 having a pattern of substantially parallel tracks 9 and a central hole 10. The pattern of substantially parallel tracks 9 constitutes a data area on an information layer, the tracks being arranged in accordance with a spiral on annular pattern of turns constituting the substantially parallel tracks. In a scanning device a head generates a beam for scanning the tracks, and, during data reading or recording, the direction of scanning of a selected track in the pattern of substantially parallel tracks 9 is along the longitudinal direction, whereas access to a different track is achieved by moving the head in a direction transverse to said longitudinal direction. For a disc-shaped record carrier the transverse direction is usually called radial direction. The record carrier may be an optical disc having an information layer of a recordable type. Examples of a recordable disc are the CD-R and CD-RW, the DVD+RW, and the Blu-ray Disc (BD). The pattern of substantially parallel tracks 9 on the recordable type of record carrier is indicated by a pre-embossed track structure provided during manufacture of the blank record carrier, for example a pregroove. Recorded information is represented on the information layer by optically detectable marks recorded along the track. The marks are constituted by variations of a physical parameter and thereby have different optical properties than their surroundings, e.g. variations in reflection.

According to the invention the record carrier is provided with boundary marks 12, 13 bordering the data area, i.e. the pattern of substantially parallel tracks 9. The boundary marks are to be detected via the beam which is also applied for scanning the tracks, i.e. no additional sensors are required for detecting the boundary marks. In particular the first boundary mark 12 borders the data area at the inner radial position, and the second boundary mark borders the data area at the outer radial position. Note that the boundary marks are fully enclosing the data area, i.e. for a disc the boundary marks are covering 360 degrees. For example the boundary marks are highly reflective boundary strips as described below with FIG. 4.

In an embodiment the boundary marks are tracks having an optically detectable different property. For example the boundary marks may have deviating marks encoded therein that are substantially longer then marks (to be) recorded in the data area. Hence a scanning signal will contain a frequency component corresponding to the lengths of the deviating marks. Alternatively the pre-embossed track structure may include the boundary marks as tracks having a deviating track wobble modulation as described below with FIG. 1c, for example a wobble frequency that is significantly higher.

In the figure the boundary marks 12,13 are drawn as a single complete turn of the spiral track. In an embodiment a number of tracks have said optically detectable different property. When moving the head in the transverse direction at a higher speed, the beam will still generate a signal component representing said variations of the physical parameter sufficiently long to be reliably detected.

FIG. 1b is a cross-section taken along the line b-b of the record carrier 11 of the recordable type, in which a transparent substrate 15 is provided with a recording layer 16 and a protective layer 17. The track structure is constituted, for example, by a pregroove 14 which enables a read/write head to follow a selected track in the pattern of substantially parallel tracks 9 during scanning. The pregroove 14 may be implemented as an indentation or an elevation, or may consist of a material having a different optical property than the material of the pregroove. The pregroove enables a read/write head to follow the track during scanning. A track structure may also be formed by regularly spread sub-tracks which periodically cause servo signals to occur. The record carrier may be intended to carry real- time information, for example video or audio information, or other information, such as computer data.

FIG. 1c shows an example of a wobble of the track. The Figure shows a periodic variation of the lateral position of the track, also called wobble. The variations cause an additional signal to arise in auxiliary detectors, e.g. in the push-pull channel generated by partial detectors in the central spot in a head of a scanning device. The wobble is, for example, frequency modulated and position information is encoded in the modulation. A comprehensive description of the prior art wobble as shown in FIG. 1c in a writable CD system comprising disc control information encoded in such a manner can be found in U.S. Pat. No. 4,901,300 (PHN 12.398) and U.S. Pat. No. 5,187,699 (PHQ 88.002).

FIG. 2 shows a scanning device having head range controlled jumping. The device is provided with means for scanning a track on a record carrier 11, which means include a drive unit 21 for rotating the record carrier 11, a head 22, a tracking servo unit 25 for positioning the head 22 on the track and a control unit 20. The tracking system positions the head on a selected track via a jump, and includes a motor for moving the head transverse to the tracks. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head may contain all optical elements, the laser and detectors as an integrated unit, usually called Optical Pickup Unit (OPU), or may contain as a movable unit only some of the optical elements, while the remaining optical elements and laser and detector are located in a unit on a fixed mechanical location, usually called split- optics, the beam being transferred between both units, e.g. via a mirror. The head further comprises (not shown) a focusing actuator for focusing the beam to the radiation spot on the track by moving the focus of the radiation beam 24 along the optical axis of said beam, and a tracking actuator for fine positioning of the spot 23 in a radial direction on the center of the track. The tracking actuator may comprise coils for radially moving an optical element or may alternatively be arranged for changing the angle of a reflecting element. For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the tracking servo unit 25 for controlling said positioning of the head and the tracking actuators. The main scanning signal 33 is processed by read processing unit 30 of a usual type including a demodulator, deformatter and output unit to retrieve the information.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits.

The device may be provided with recording means for recording information on a record carrier of a writable or re-writable type. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the power of the beam of radiation is controlled by modulator 29 to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

The improvements described below relate to an optical disc drive sledge mechanism. In order to be able to read/write selected tracks on a complete disc the head is mounted on a movable sledge. The head on the sledge is movable from an inner to an outer radius of the optical disc by a motor. The mechanical range of the head movement will be designed to cover at least the maximal radial range of the record carrier. Data to be accessed subsequently may be scattered all over the disc requiring jumping of the laser spot from one (defined) place on the disc to another (also defined place). Hence the jumps are needed to access the complete disc; the process usually called seeking featuring the sledge for radially positioning the head. If jumping is performed relatively slow, a track count mechanism is able to count track-crossings obtained from the optical spot detector arrangement. The track count is compared with the pre-calculated value, and data read back is started once the target count is reached, as discussed with the prior art document U.S. Pat. No. 6,215,739. However for high density record carriers, and while jumping at high speed, track counting is unreliable or even impossible. Since there is a need to reduce access times, high speed jumping may be done based on an estimated distance of movement without a reliable track count mechanism. However there still is a need to limit the motor in order not to exceed the mechanical range of the sledge movement, because physical damage or excessive wear may occur otherwise.

According to the invention the device has a head range unit 32 for detecting the boundary marks via the beam and controlling the motor for limiting said transverse movement of the head as explained below.

FIG. 3 shows a tracking servo system for positioning the head on the track and limiting the transverse movement to a head range. The tracking system corresponds to the tracking servo unit 25 in FIG. 2. The head 22 generates a scanning signal 41, and is mounted on a surrounding support unit, usually called sledge or carriage 47, which is mechanically coupled to a rail 46. A motor 40 is coupled to the carriage 47 for moving the head 22 along the rail transverse to the tracks. In practical embodiments the rail 46 may include supporting rail on which the carriage is positioned by wheels, a longitudinal worm axis, etc, all well known in the art of mechanical construction of optical disc drives.

The tracking servo system includes, for constituting a main servo loop, the motor 40, a position unit 50 for generating a position signal 45 indicating the actual position of the head, and an amplifying unit 44. The amplifying unit 44 generates a driving signal 49 coupled to the motor 40 based on an error signal from error unit 42 that receives as input a selected target position signal 43 and the position signal 45. The position signal 45 may be based on track counting, or may be based on a global position sensor, which generate a fairly inaccurate position of the head, or may be based on a distance of movement as explained below.

The head range unit 32 is arranged for detecting the boundary marks via the beam and controlling the motor for limiting said transverse movement of the head. In particular the range of movement is limited to a head range corresponding to the pattern of substantially parallel tracks bordered by the boundary marks.

In a first embodiment the head range unit is arranged for detecting the boundary marks during operational use, in particular during jumping. As soon as the head range unit detects that the head reaches an outer limit of the head range, the motor is controlled to stop as indicated by the switching unit 48. It is noted that the control of stopping the motor when the boundary marks are reached may be executed on various location in the tracking servo loop, e.g. by controlling the error unit 42 or the target position signal 43

In an embodiment the head range unit 32 includes a detector 34 for detecting a predefined level of the scanning signal 33 for detecting the presence of the boundary mark via the beam. For example, a threshold level is predetermined based on an amount of radiation averagely reflected from the pattern of substantially parallel tracks, including a predetermined margin to prevent false alarm. Subsequently the detector monitors a reflection signal from a detector in the head which represents a total amount of reflected radiation. The reflection signal may be the main scanning signal itself, or a selection or combination of various sub-detector signals commonly available from the OPU.

FIG. 4 shows a record carrier having boundary strips and a reflected signal level. A record carrier 70 has an outer boundary strip 71 and an inner boundary strip 72. The boundary strips enclose a data area 77 on the record carrier, i.e. are bordering the pattern of substantially parallel tracks for containing data. The boundary strips have an optically detectable property that has a value that is substantially different from the value in the data area 77. For example the boundary strips are highly reflective, whereas the average reflection in the data area is significantly lower. In a lower part of FIG. 4 a scanning signal 73 is shown for a head moving in a direction transverse to the tracks. When the head is positioned on the boundary strips, a high signal level well above a threshold level 74 is found. The outer boundary strip 71 results in a boundary signal level 75, and inner boundary strip 72 in signal level 76, whereas the data area has a normal signal level 78. In the example the strips are highly reflective, and the boundary signal level is higher than the normal level. However, the boundary signal level may also be lower, or a different optical property may be used such as a substantially different wobble frequency of the tracks in the boundary strips. When the spot enters the highly reflective area, the level of the low-pass filtered HF-signal increases. Simple threshold detection can detect if the OPU enters the inner or outer boundary strip of the disc.

In an embodiment the device has a pregroove demodulation unit for detecting pregroove modulation in the scanning signal. The scanning signal from the beam is processed in the front-end unit 31 to derive a component representing the pregroove modulation. Recording control information is retrieved from the pregroove modulation by the pregroove demodulation unit as discussed above with reference to FIG. 1c. In an embodiment the record carrier as discussed above with FIG. 1 has, for constituting the boundary marks, a different pregroove modulation. For detecting said different pregroove modulation, the detector 34 is coupled to the pregroove demodulation unit.

In an embodiment of the device, to enable distance based jumping, the distance of movement of the head is detected. There is a need to calculate the distance between the position of the head and a selected track, and thereto the current position of the head and the target position of the selected track are determined. Moreover it is necessary to take into account a sledge position transfer function (e.g. distance per second per volt of motor drive signal) called motor transfer rate. The control unit 20 is arranged for determining the position of the selected track, and for calculating a distance of moving the head based on the position of the selected track and a current position of the head. The positions may be derived from the physical addresses of data blocks in the track. For enabling the distance based jumping there is a need to know the movement of the sledge.

In an embodiment the position signal 45 is based on a number of revolutions of the motor. The revolutions may, for example, be detected by a sensor as in U.S. Pat. No. 6,215,739. A translation of revolutions to a radial distance (a position in mm) can be performed using a motor transfer rate. The motor transfer rate is indicative of a ratio of a number of the revolutions and a head move distance. The motor transfer rate may be calibrated, and the device may store the motor transfer rate as determined during a calibration process. Similarly the target position signal 43 may be expressed in revolutions or in mm. The position signal is coupled to the tracking servo unit 25 for positioning the head on the selected track.

It is noted that the position unit 50 may be arranged to read information from the tracks of the record carrier for detecting the actual position of the head. Additionally, during slow transverse movement of the head, a track crossing signal may be generated, and the tracks crossed may be counted. Such slow jumps may be applied to jump short distances.

In an embodiment the position unit 50 is arranged for determining the amount of revolutions of the motor based on the driving signal 49 coupled to the motor. For example the motor may be arranged as a stepping motor. The number of pulses applied to the stepping motor may be counted. Alternatively the motor may be a (3-phase) synchronous motor, driven by sinusoidal drive signals having a known period related to the amount of revolutions of the motor. The motor transfer rate parameter indicates the actual relation between the movement of the head in mm and the controlled periodic drive signals to the motor. It is noted that for such relation to be reliable it is required that the motor (e.g. of the synchronous or stepping type) is able to rotate according to the drive signals without slipping.

In a second embodiment of the device the control unit 20 is arranged for, after inserting the record carrier, performing a calibration process based on the boundary marks for determining and storing the head range. The head range unit 32 is arranged for limiting said transverse movement of the head based on the stored head range. It is noted that now the boundary marks are detected only once during calibration, instead of continuously during operational use monitoring the boundary marks. During operational use and seeking the head range unit detects and monitors the actual position of the head and compares the actual position with the stored head range. As soon as the actual position exceeds the stored maxima, the motor is controlled to stop. If necessary, e.g. due to falsely stopping the motor, the head range and/or the detected actual position of the head may be recalibrated later.

FIG. 5 shows a flow chart of a head range calibration procedure. In a first step LCK 81 a wobble lock is performed and the presence of a record carrier is detected. An estimate of the actual position of the head may based on position information, e.g. a wobble encoded address. Step 81 assumes a record carrier having wobble, but the presence of the record carrier and a rough position of the head may also be based on reading HF data from the track from the main scanning signal. In step JIN 82 a small jump is made towards the inner side of the disc. In step SMI 83 it is tested if the boundary mark on the inner side of the data area is reached, e.g. the highly reflective inner boundary strip 72. In a next step JOUT 84 the sledge is jumping slowly towards the outer side of the disc, while counting the number of tracks or the number of revolutions of the motor for detecting a distance of head movement. In a step SMO 85 it is tested if the boundary mark on the outer side of the data area is reached, e.g. the highly reflective outer boundary strip 71. The boundary marks may also be boundary patterns in the wobble as shown in FIG. 1c, etc. In step DET 86 determines, from the distance detected in step JOUT 84, a maximum range of movement of the head between the first boundary mark and the second boundary mark, which distance corresponds to the data area and therefore constitutes the head range. Subsequently in step STOR 87 the head range is stored for use by the head range unit 32.

The step DET 86 may determine the distance between the boundary marks or boundary strips from the tracks counted by reading a track pitch ratio parameter from the record carrier, or by calculating the positions of the first and second boundary mark in dependence of their respective physical addresses indicating a linear position along the track.

The improvements are particularly relevant for so called small form factor devices, because high speed jumping without a position sensor is achieved. In general, in battery powered, portable devices, the amount of power dissipated for seeking in the tracking servo system may be reduced. The reduction is achieved by the fact that the head never leaves the available data area of the actual record carrier during seeking.

Although the invention has been mainly explained by embodiments using disc shaped optical record carriers, the invention is also suitable for other record carriers such as rectangular optical cards, annular track patterns, magnetic discs or any other type of information storage system that needs positioning a head. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Device for scanning a selected track in a pattern of substantially parallel tracks on a record carrier (11) via a beam of radiation (24),
the record carrier comprising a first boundary mark (71) on a predefined first transverse position, and a second boundary mark (72) on a predefined second transverse position, the first and second boundary mark bordering the pattern of substantially parallel tracks, and
the device comprising
a head (22) for providing the beam,
control means (20) for determining a position of the selected track,
tracking means (25) for positioning the head on the selected track via a jump, the tracking means comprising a motor (40) for moving the head transverse to the tracks, and
head range means (32) for detecting the boundary marks via the beam and controlling the motor for limiting said transverse movement of the head to a head range corresponding to the pattern of substantially parallel tracks bordered by the boundary marks.

2. Device as claimed in claim 1, wherein the head range means (32) are arranged for detecting the boundary marks via the beam during said jump.

3. Device as claimed in claim 1, wherein the head range means (32) comprises detection means (34) for detecting, from a detector signal from the head, an amount of reflected radiation deviating at least a predetermined amount from an amount of reflected radiation from the pattern of substantially parallel tracks.

4. Device as claimed in claim 3, wherein the detection means (34) are arranged for detecting a level of the detector signal exceeding a predetermined threshold, the boundary marks on the record carrier being highly reflective boundary strips having a reflection that is at least a predefined amount above an average reflection of the pattern of substantially parallel tracks.

5. Device as claimed in claim 1, wherein the control means (20) are arranged for, after inserting the record carrier, performing a calibration process based on the boundary marks for determining and storing the head range, and
the head range means (32) are arranged for limiting said transverse movement of the head based on the stored head range.

6. Device as claimed in claim 5, wherein the calibration process comprises
positioning (82,83) the head on a first position based on the first boundary mark on the record carrier, and subsequently, while detecting an amount of movement from the motor,
positioning (84,85) the head on a second position based on the second boundary mark on the record carrier,
determining (86) the head range from the amount of movement between the first position and the second position, and
storing (87) the head range.

7. Device as claimed in claim 1, wherein the tracking means (25) are arranged for positioning the head in dependence of an amount of revolutions of the motor.

8. Device as claimed in claim 7, wherein the device comprises position means (50) for detecting the amount of revolutions of the motor in dependence of a drive signal coupled to the motor.

9. Record carrier having a pattern of substantially parallel tracks to be scanned via a beam of radiation, which record carrier comprises a first boundary mark (71) on a predefined first transverse position, and a second boundary mark (72) on a predefined second transverse position, the first and second boundary mark bordering the pattern of substantially parallel tracks

10. Record carrier as claimed in claim 9, wherein the boundary marks (71,72) on the record carrier are highly reflective boundary strips having a reflection that is at least a predefined amount above an average reflection of the pattern of substantially parallel tracks.
